(19) United States
(12) Patent Application Publication
(10) Pub. No.: US 2022/0358367 A1
(43) Pub. Date: Nov. 10, 2022

(54) PREDICTION METHOD AND DEVICE FOR CLEARING PRICE OF AUXILIARY SERVICE FOR PEAK REGULATION BASED ON DEEP LEARNING

(71) Applicants: North China Electric Power University, Beijing (CN); State Grid Electric Vehicle Service Co., Ltd, Beijing (CN)

(72) Inventors: Mingguang LIU, Beijing (CN); Mengjiao ZOU, Beijing (CN); Dunnan LIU, Beijing (CN); Wen WANG, Beijing (CN); Xiaofeng PENG, Beijing (CN); Yue ZHANG, Beijing (CN); Ye YANG, Beijing (CN); Jun WANG, Beijing (CN); Heping JIA, Beijing (CN); Shu SU, Beijing (CN); Tingting ZHANG, Beijing (CN); Lingxiang WANG, Beijing (CN); Shanshan SHANG, Beijing (CN)

(21) Appl. No.: 17/729,859

(22) Filed: Apr. 26, 2022

(30) Foreign Application Priority Data
Apr. 28, 2021 (CN) 202110465576.5

(51) Int. Cl. G06N 3/08; G06Q 40/04; G06K 9/62; G06N 20/10

(52) U.S. Cl. CPC G06N 3/084; G06Q 40/04; G06K 9/6223; G06N 20/10

(57) ABSTRACT

Disclosed is a prediction method and device for a clearing price of an auxiliary service for peak regulation, including: acquiring continuous N days of historical data of clearing prices of an auxiliary service market for peak regulation and respectively moving data of original clearing prices forwards by 1, 2, . . . k days, so as to obtain D−1, D−2 . . . D−k data columns; performing first-round training and prediction by adopting a BP (Back Propagation) neural network, a BP neural network optimized by a PSO (Particle Swarm Optimization) algorithm and an LSSVM (Least Square Support Vector Machine), and forming a BP-expansion column, a PSO_BP-expansion column and an LSSVM-expansion column; training the BP neural network by taking first N−k days of time points and D−1, D−2 . . . D−k clearing prices, the BP-expansion column, the PSO_BP-expansion column, the LSSVM-expansion column and the original clearing prices as training data; and performing prediction for the clearing price.

### CROSS REFERENCE TO RELATED APPLICATIONS

This application claims foreign priority of Chinese Patent Application No. 202110465576.5, filed on Apr. 28, 2021 in the China National Intellectual Property Administration, the disclosures of all of which are hereby incorporated by reference.

### TECHNICAL FIELD

The present invention relates to the technical field of prediction for electricity price, and particularly relates to a prediction method and device for a clearing price of an auxiliary service for peak regulation based on deep learning.

### BACKGROUND OF THE PRESENT INVENTION

A trading market of an auxiliary service for peak regulation will be an important component of construction of State Grid in the future. Short-term influence factors of a clearing price of the trading market of the auxiliary service for peak regulation comprise a time point, a cycle attribute, whether the time is a holiday or a festival, a load, total active power of wind power, photovoltaic output and so on, wherein the factors such as the time point, the cycle attribute, whether the time is the holiday or the festival and the like are in weak correlation with the clearing price of the trading market of the auxiliary service for peak regulation; the quotation of a thermal power plant is relatively subjective, so as to be difficult to predict, and the power generation power of wind and light is difficult to acquire as the power generation power of the wind and the light is short in cyclicality and large in volatility; and the existing market disclosure mechanism is not published, and data of an operating load of an electric power system is confidential. The influence factors cause that the prediction for the clearing price of the trading market of the auxiliary service for peak regulation is difficult, and a prediction research can be carried out only by mining data characteristics of the clearing price, leading to poor adaptability of the existing prediction algorithm. As the reformation of the electric power system and the objectives of ‘peak carbon dioxide emissions’ and ‘carbon neutral’ are carried out, more subjects will participate into the trading market of the auxiliary service for peak regulation in the future, and accurate prediction for the clearing price has a significance for the decision for the quotation of market subjects.

For the existing problems of the prediction for the clearing price of the trading market of the auxiliary service for peak regulation, the present invention provides a prediction method for the clearing price of the trading market of the auxiliary service for peak regulation based on parallel deep learning, so that all the entities of the market participate into market competition more efficiently: a power purchase party can carry out strategic quotation to realize own profit maximization according to price prediction, and a power generation party can peep the requirements of electric quantities in the market from the price prediction, so as to select comparatively excellent power generating capacity and avoid too much power generation to cause waste or insufficient power generation to cause loss.

### SUMMARY OF PRESENT INVENTION

The present invention aims to provide a prediction method and device for a clearing price of an auxiliary service for peak regulation based on deep learning in order to overcome the defects in the prior art, so as to avoid too much power generation to cause waste or insufficient power generation to cause loss.

In order to solve the technical problems, the present invention adopts the following technical solutions:

The prediction method for the clearing price of the auxiliary service for peak regulation based on deep learning comprises the following steps:

acquiring continuous N days of historical data of clearing prices of an auxiliary service market for peak regulation and obtaining N×m original clearing prices by taking a clearing interval as a step size, so as to form original clearing data columns; and respectively moving data of the N×m original clearing prices forwards by 1, 2, days and respectively supplementing missing 1, 2, . . . k days of data by utilizing original clearing prices on a first day, so as to obtain D−1, D−2 . . . D−k data columns;

carrying out first-round training and prediction by adopting a BP (Back Propagation) neural network, a BP neural network optimized by a PSO (Particle Swarm Optimization) algorithm and an LSSVM (Least Square Support Vector Machine), and forming a BP-expansion column, a PSO_BP-expansion column and an LSSVM-expansion column;

carrying out second-round training by utilizing the BP neural network: training the BP neural network by taking first N−k days of time points and D−1, D−2 . . . D−k clearing prices, the BP-expansion column, the PSO_BP-expansion column, the LSSVM-expansion column and the original clearing prices as training data, and taking last k days of data as test data, so as to obtain a trained BP neural network;

carrying out prediction for a clearing price on a to-be-predicted day by utilizing the trained BP neural network.

Further, the method of carrying out first-round training and prediction by adopting the BP neural network and forming the BP-expansion column comprises:

training the BP neural network by taking the first N−k days of time points and D−1, D−2 . . . D−k clearing prices and the original clearing prices as the training data, and taking output of the BP neural network as first N−k days of clearing data;

training the BP neural network by taking the first N−k days of time points and D−1, D−2 . . . D−k clearing prices and the original clearing prices as the training data and taking the last k days of data as the test data, and carrying out prediction by utilizing the trained BP neural network, so as to obtain last k days of clearing prices;

taking first N−k days of clearing prices and the last k days of clearing prices, which are obtained above, as the BP-expansion column.

Further, the method of carrying out first-round training and prediction by adopting the BP neural network optimized by the PSO algorithm and the LSSVM and forming the PSO_BP-expansion column and the LSSVM-expansion column is consistent with the method of carrying out first-round training and prediction by adopting the BP neural network and forming the BP-expansion column.

Further, the method of carrying out prediction for the clearing price on the to-be-predicted day by utilizing the trained BP neural network comprises: acquiring N days of historical data of clearing prices of the auxiliary service market for peak regulation before the to-be-predicted day, so as to form original clearing data columns; respectively moving data of original clearing prices forwards by 1, 2 . . . k days, and supplementing missing 1, 2 . . . k days of data by utilizing original clearing prices on a first day, so as to obtain D−1, D−2 . . . D−k data columns; and inputting the first N−k days of time points and D−1, D−2 . . . D−k clearing prices and the original clearing prices into the trained BP neural network, so as to obtain the clearing price on the to-be-predicted day.

The device for the prediction method for the clearing price of the auxiliary service for peak regulation based on deep learning comprises:

a data acquisition module, used for acquiring the continuous N days of historical data of the clearing prices of the auxiliary service market for peak regulation and obtaining the N×m original clearing prices by taking the clearing interval as the step size, so as to form the original clearing data columns; and respectively moving the data of the N×m original clearing prices forwards by 1,2, . . . k days and respectively supplementing the missing 1,2, . . . k days of data by utilizing the original clearing prices on the first day, so as to obtain the D−1, D−2 . . . D−k data columns;

a data expansion column acquisition module, used for carrying out first-round training and prediction by adopting the BP neural network, the BP neural network optimized by the PSO algorithm and the LSSVM, and forming the BP-expansion column, the PSO_BP-expansion column and the LSSVM-expansion column;

a BP neural network training and acquisition module, used for carrying out second-round training by utilizing the BP neural network: training the BP neural network by taking the first N−k days of time points and D−1, D−2 . . . D−k clearing prices, the BP-expansion column, the PSO_BP-expansion column, the LSSVM-expansion column and the original clearing prices as the training data, and taking the last k days of data as the test data, so as to obtain the trained BP neural network;

a prediction module for the clearing price on the to-be-predicted day, used for carrying out prediction for the clearing price on the to-be-predicted day by utilizing the trained BP neural network.

Computing equipment comprises one or more processing units; and a storage unit, used for storing one or more programs, wherein when the one or more programs are executed by the one or more processing units, the one or more processing units execute the prediction method for the clearing price of the auxiliary service for peak regulation based on deep learning.

A computer readable storage medium with non-volatile program codes capable of being executed by a processor is used for realizing the steps of the prediction method for the clearing price of the auxiliary service for peak regulation based on deep learning when computer programs are executed by the processor.

The present invention has the advantages and the positive effects that:

According to the prediction method and the device, the current factor of the deficiency of related parameter data of the price, which are caused by market competition and data confidentiality, is overcome, the data related to the original data is formed by utilizing a data expansion manner, and meanwhile, the training learning is carried out on the original data by utilizing the algorithm; and due to the influences of the volatility of a new energy source and the uncertainty of user-end requirements, the clearing price of the market for peak regulation is extremely large in volatility, and the cyclicality thereof is difficult to find, so that the problem that the clearing price of the auxiliary service for peak regulation is difficult to predict by adopting the original prediction method is solved.

### DESCRIPTION OF THE DRAWINGS

The technical solutions of the present invention are further described in detail below through combination with the drawings and embodiments, but it should be known that the drawings are designed only for the purpose of explanation, so as not to limit the scope of the present invention. Additionally, unless it is specially pointed out, the drawings are only intended to conceptually illustrate structures described here, and are not necessarily drawn proportionally.

FIG. 1 is a diagram of carrying out first-round prediction on predicted values of last three days of clearing prices by adopting a BP neural network according to an embodiment of the present invention;

FIG. 2 is a diagram of carrying out first-round prediction on the predicted values of the last three days of clearing prices by adopting a BP neural network optimized by a PSO algorithm according to an embodiment of the present invention;

FIG. 3 is a diagram of carrying out first-round prediction on the predicted values of the last three days of clearing prices by adopting an LSSVM according to an embodiment of the present invention; and

FIG. 4 is a diagram of carrying out second-round prediction on the predicted values of the last three days of clearing prices by adopting the BP neural network according to an embodiment of the present invention.

### DETAILED DESCRIPTION OF PREFERRED EMBODIMENTS

Firstly, it should be noted that the specific structures, characteristics, advantages and so on of the present invention are specifically described hereinafter in an example manner, however, all the description is only used for description, and should not be understood as any limit to the present invention. Additionally, any single technical characteristic described or implied in all embodiments mentioned in the text can still be randomly combined or deleted continuously among the technical characteristics (or equivalents thereof), so as to obtain other more embodiments of the present invention, which are possibly not directly mentioned in the text.

It should be noted that the embodiments in the present application and the characteristics in the embodiments can be combined with each other in the absence of conflict.

The embodiment provides a prediction method for a clearing price of an auxiliary service for peak regulation based on deep learning, which comprises the following steps:

acquiring continuous N days of historical data of clearing prices of an auxiliary service market for peak regulation and obtaining N×m original clearing prices by taking a clearing interval as a step size, so as to form original clearing data columns; and respectively moving data of the N×m original clearing prices forwards by 1,2, . . . k days and respectively supplementing missing 1,2, . . . k days of data by utilizing original clearing prices on a first day, so as to obtain D−1, D−2 . . . D−k data columns;

carrying out first-round training and prediction by adopting a BP neural network, a BP neural network optimized by a PSO algorithm and an LSSVM, and forming a BP-expansion column, a PSO_BP-expansion column and an LSSVM-expansion column;

carrying out second-round training by utilizing the BP neural network: training the BP neural network by taking first N−k days of time points and D−1, D−2 . . . D−k clearing prices, the BP-expansion column, the PSO_BP-expansion column, the LSSVM-expansion column and the original clearing prices as training data, and taking last k days of data as test data, so as to obtain a trained BP neural network;

carrying out prediction for a clearing price on a to-be-predicted day by utilizing the trained BP neural network.

Specifically, the method of carrying out first-round training and prediction by adopting the BP neural network and forming the BP-expansion column comprises:

training the BP neural network by taking the first N−k days of time points and D−1, D−2 . . . D−k clearing prices and the original clearing prices as the training data, and taking output of the BP neural network as first N−k days of clearing data;

training the BP neural network by taking the first N−k days of time points and D−1, D−2 . . . D−k clearing prices and the original clearing prices as the training data and taking the last k days of data as the test data, and carrying out prediction by utilizing the trained BP neural network, so as to obtain last k days of clearing prices;

taking first N−k days of clearing prices and the last k days of clearing prices, which are obtained above, as the BP-expansion column.

Further, the method of carrying out first-round training and prediction by adopting the BP neural network optimized by the PSO algorithm and the LSSVM and forming the PSO_BP-expansion column and the LSSVM-expansion column is consistent with the method of carrying out first-round training and prediction by adopting the BP neural network and forming the BP-expansion column.

The above step of carrying out prediction by using the BP neural network comprises the following specific steps:

initialization for the network: the BP neural network contains input layers i, hidden layers j and output layers k, the upper layer and the lower layer are connected with each other, but the same layers are not connected with each other; a network weight ω representing the connection strength of two neural cells exists between an upper-layer neural cell and a lower-layer neural cell; the learning rate is η; an input vector is an output vector is X̅=[x1, x2 . . . xi . . . xn], i=1, 2, . . . , n: an output vector is Y̅=[y1, y2 . . . yk . . . ym], k=1, 2, . . . , m; output of all neural cells of a t^{th} hidden layer is: ā^{(t)}=[a₁^{(t), a}₂^{(t)} . . . aⱼ^{(t)} . . . aₛₜ^{t}], j=1, 2, . . . , st; and a unipolar S function:

$$\text{?}$$

$$\text{?} \text{indicates text missing or illegible when filed}$$

is adopted as an activation function;

outputting of the hidden layers and the output layers:

$$\text{?}$$

$$\text{?} \text{indicates text missing or illegible when filed}$$

output of the hidden layers is:

$$\text{?}$$

$$\text{?} \text{indicates text missing or illegible when filed}$$

output of the output layers is:

$$\text{?}$$

$$\text{?} \text{indicates text missing or illegible when filed}$$

wherein netᵢ^{(t)} represents input of an i^{th} neural cell of a t^{th} layer, and f(·) represents an activation function; it is assumed that the number of nodes of the input layers is n, the number of nodes of the hidden layers is 1, and the number of nodes of the output layers is m; a weight from the input layer to the hidden layer is ωᵢⱼ, a weight from the hidden layer to the output layer is ωⱼₖ, a bias from the input layer to the hidden layer is aⱼ, and a bias from the hidden layer to the output layer is bₖ; and ωᵢⱼ^{(t)} represents a weight between an i^{th} neural cell of the input layer and a j^{th} neural cell of the t^{th} hidden layer, and bᵢ^{(t)} represents a bias of an i^{th} neural cell of the t^{th} layer;

an error is defined as:

$$\text{?}$$

$$\text{?} \text{indicates text missing or illegible when filed}$$

wherein E(i) represents a training error of a single sample:

$$\text{?}$$

$$\text{?} \text{indicates text missing or illegible when filed}$$

wherein m represents the sum of training samples, and dᵢ represents expected output of x₁;

updating of weights: when the error is

$$\text{?}$$

$$\text{?} \text{indicates text missing or illegible when filed}$$

the error is fed back forwards from a latter-layer neural cell level by level, iterations are carried out for updating the weights and the biases by adopting the BP neural network in a feedback process, and the equations are

$$\text{?}$$

$$\text{?} \text{indicates text missing or illegible when filed}$$

A specific implementation process of carrying out first-round prediction by adopting the BP neural network optimized by the PSO algorithm is the same as a process of carrying out first-round prediction by adopting the BP neural network, and the purpose is forming a column of new predicted data of N days of clearing prices (the PSO_BP-expansion column). The specific steps of carrying out prediction by adopting the BP neural network optimized by the PSO algorithm is the same as the specific steps of carrying out prediction by adopting the BP neural network, but network weights and thresholds of the BP neural network are optimized by the PSO algorithm; and when the structure of the BP neural network (the number of layers and the number of nodes of each layer) is more complicated, the algorithm has the defects of being low in learning rate, being easy to fall into a local minimum, being poor in stability and so on. Learning is carried out through swarm intelligence by the PSO algorithm, and the PSO algorithm has better global optimization ability. The PSO algorithm is introduced into a BP neural network model, so as to increase the rate of convergence of the traditional BP neural network algorithm. The specific steps are: carrying out coding by taking connection weights and thresholds of all layers of the BP neural network as particles, replacing with particle swarm position vectors and continuously carrying out iteration by the algorithm, so as to obtain optimal population particles; and carrying out decoding, transforming the optimal population particles into optimal solutions, and then taking the optimal solutions as global optimal connection weights and thresholds of the BP neural network, so as to establish a BP neural network algorithm model optimized by PSO.

A specific implementation process of carrying out first-round prediction by adopting the LSSVM is the same as the process of carrying out first-round prediction by adopting the BP neural network, and the purpose is forming a column of new predicted data of N days of clearing prices (the LSSVM-expansion column).

The step of carrying out prediction by using the LSSVM comprises the following specific steps:

obtaining a regression function:

f(x)=ω^{T}·ϕ(x)+b

wherein ω represents a weight vector; φ(x) represents a mapping function from a low-dimensional space to a high-dimensional space; b represents a deviation term; and at the moment, an objective function and a constraint condition are:

$$\text{?}$$

$$\text{?} \text{indicates text missing or illegible when filed}$$

wherein ei represents an error; e∈R1×1 represents an error vector; C represents a penalty parameter for adjusting the penalty degree for an error term; and a Lagrange's multiplier λ is introduced, λ∈R1×1, and a constrained optimization problem is transformed into an unconstrained optimization problem:

$$\text{?}$$

$$\text{?} \text{indicates text missing or illegible when filed}$$

from a KKT (Karush-Kuhn-Tucker) optimization condition, obtaining:

$$\{ \begin{matrix}\frac{\partial L}{\partial ω} = 0 \to ω = {{\sum }_{i = 1}}^{i} {λ}_{i} ϕ ( {x}_{i} ) \\ \frac{\partial L}{\partial b} = 0 \to {{\sum }_{i = 1}}^{i} {λ}_{i} = 0 , i = 1 , 2 , … , l \\ \frac{\partial L}{\partial {e}_{i}} = 0 \to {λ}_{i} = {Ce}_{i} , i = 1 , 2 , … , l \\ \frac{\partial L}{\partial {λ}_{i}} = 0 \to {ω}^{T} \cdot ϕ ( {x}_{i} ) + b + {e}_{i} - {y}_{i} = 0 , i = 1 , 2 , … , l\end{matrix}$$

eliminating ω and e, so as to obtain a solution of the formula (3-24):

$$[ \begin{matrix}0 & {E}^{T} \\ E & K + {C}^{- 1} I\end{matrix} ] [ \begin{matrix}b \\ λ\end{matrix} ] = [ \begin{matrix}0 \\ Y\end{matrix} ]$$

wherein E represents [1, 1, . . . , 1]T; I represents a unit matrix; λᵢ=[λ₁, λ₂, . . . λ_{I}]T; Y=[Y1, Y2, . . . YI]T; K represents a kernel function which is nonlinearly mapped to the high-dimensional space; and an optimal linear regression function of the LS-SVM is obtained:

$$f ( x ) = {{\sum }_{i = 1}}^{i} {λ}_{i} K ( x , {x}_{i} ) + b .$$

Specifically, the method of carrying out prediction for the clearing price on the to-be-predicted day by utilizing the trained BP neural network comprises: acquiring N days of historical data of clearing prices of the auxiliary service market for peak regulation before the to-be-predicted day, so as to form original clearing data columns; respectively moving data of original clearing prices forwards by 1, 2 . . . k days, and supplementing missing 1, 2 . . . k days of data by utilizing original clearing prices on a first day, so as to obtain D−1, D−2 . . . D−k data columns; and inputting first N−k days of time points and D−1, D−2 . . . D−k clearing prices and the original clearing prices into the trained BP neural network, so as to obtain the clearing price on the to-be-predicted day.

A prediction device for the clearing price of the auxiliary service for peak regulation based on deep learning comprises:

a data acquisition module, used for acquiring the continuous N days of historical data of the clearing prices of the auxiliary service market for peak regulation and obtaining the N×m original clearing prices by taking the clearing interval as the step size, so as to form the original clearing data columns; and respectively moving the data of the N×m original clearing prices forwards by 1,2, . . . k days and respectively supplementing the missing 1,2, . . . k days of data by utilizing the original clearing prices on the first day, so as to obtain the D−1, D−2 . . . D−k data columns;

a data expansion column acquisition module, used for carrying out first-round training and prediction by adopting the BP neural network, the BP neural network optimized by the PSO and the LSSVM, and forming the BP-expansion column, the PSO_BP-expansion column and the LSSVM-expansion column;

a BP neural network training and acquisition module, used for carrying out second-round training by utilizing the BP neural network: training the BP neural network by taking the first N−k days of time points and D−1, D−2 . . . D−k clearing prices, the BP-expansion column, the PSO_BP-expansion column, the LSSVM-expansion column and the original clearing prices as the training data, and taking the last k days of data as the test data, so as to obtain the trained BP neural network;

a prediction module for the clearing price on the to-be-predicted day, used for carrying out prediction for the clearing price on the to-be-predicted day by utilizing the trained BP neural network.

Computing equipment comprises:

one or more processing units;

a storage unit, used for storing one or more programs,

wherein when the one or more programs are executed by the one or more processing units, the one or more processing units execute the above prediction method for the clearing price of the auxiliary service for peak regulation based on deep learning; it should be noted that the computing equipment may comprise, but not limited to, the processing units and the storage unit; and those skilled in the art may understand that the computing equipment comprises the processing units and the storage unit, which is not the limit to the computing equipment, the computing equipment may comprise more components, or a combination of certain components, or different components, and for example, the computing equipment may also comprise input/output equipment, network access equipment, a bus and so on.

A computer readable storage medium with non-volatile program codes capable of being executed by a processor is used for realizing the steps of the prediction method for the clearing price of the auxiliary service for peak regulation based on deep learning when computer programs are executed by the processor; it should be noted that the readable storage medium, for example, may be, but not limited to, a system, a device or a component of electricity, magnetism, light, electromagnetism, an infrared ray or a semi-conductor, or any combination thereof; and programs contained in the readable medium may be transmitted by any appropriate medium, comprising, but not limited to, a wireless medium, a wired medium, an optical cable, an RF (Radio Frequency) medium and so on, or any appropriate combination thereof. For example, one program design language or any combination of more program design languages may be used for editing the program codes used for executing operations of the present invention; and the program design language comprises an object-oriented program design language, such as Java, C++ and so on, and also comprises a conventional procedural program design language, such as a C language or a similar program design language. The program codes may be completely executed in computing equipment of a user, be partly executed in user equipment, be executed as an independent software package, or be completely executed in remote computing equipment or server. In the case of involving the remote computing equipment, the remote computing equipment may be connected to the computing equipment of the user by any type of network, comprising an LAN (Local Area Network) or a WAN (Wide Area Network), or may be connected to external computing equipment (for example, be connected by an Internet by utilizing an Internet service provider).

As an example, in the embodiment, a clearing price of an auxiliary service for peak regulation at a certain region is adopted for carrying out verification, continuous 80 days of data of electricity prices is selected for carrying out prediction for clearing prices, and after data of the clearing prices is processed, the processed data of the clearing prices is shown in the following table:

TABLE 1
Clearing Prices

| Time points | D-1 | D-2 | D-3 | Clearing prices |
|---|---|---|---|---|
| 1 | 0 | 0 | 0 | 0 |
| 2 | 0 | 0 | 0 | 0 |
| 3 | 10 | 10 | 10 | 10 |
| . . . | . . . | . . . | . . . | . . . |
| 96 | 0 | 0 | 0 | 0 |
| 1 | 0 | 0 | 0 | 0 |
| 2 | 0 | 0 | 0 | 0 |
| 3 | 30 | 0 | 10 | 90 |
| . . . | . . . | . . . | . . . | . . . |
| 96 | 0 | 0 | 0 | 0 |
| . . . | . . . | . . . | . . . | . . . |
| 1 | 0 | 0 | 0 | 0 |
| 2 | 0 | 0 | 0 | 0 |
| 3 | 180 | 300 | 400 | 100 |
| . . . | . . . | . . . | . . . | . . . |
| 96 | 0 | 0 | 0 | 0 |

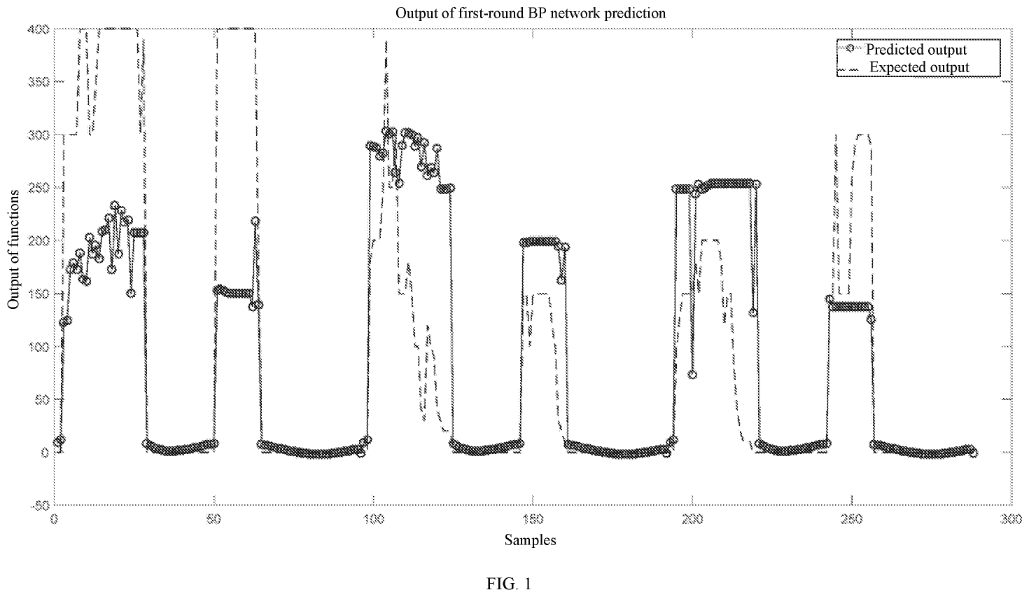

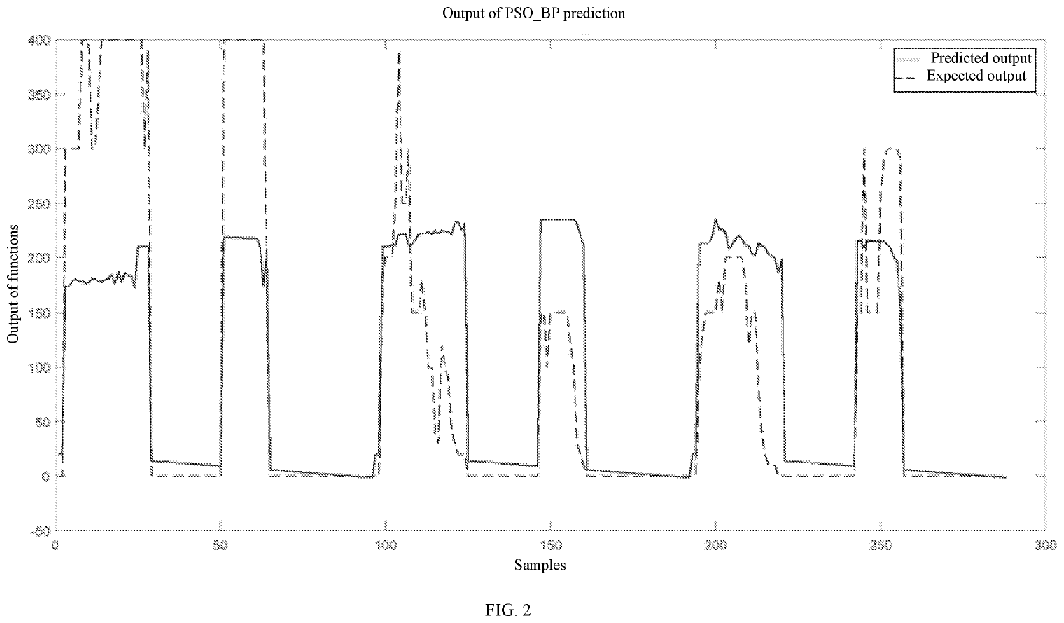

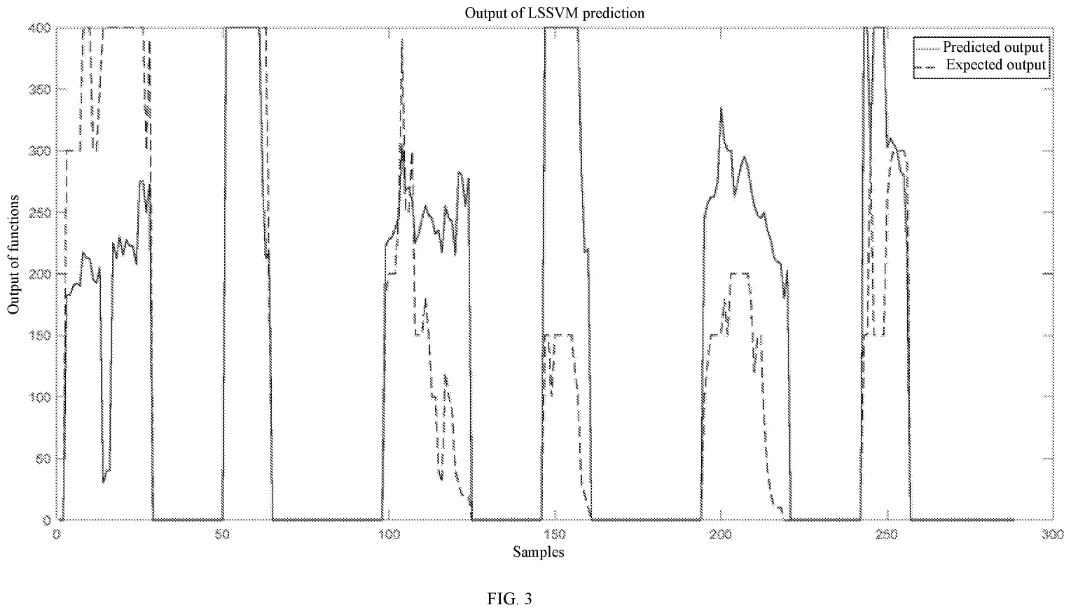

First-round prediction is carried out by adopting a BP neural network, comprising: firstly, inputting first 77 days of time points, D−1, D−2 and D−3 as influence factors, and meanwhile, predicting first 77 days of data by taking the first 77 days of time points, D−1, D−2 and D−3 and original clearing prices as training data, wherein at the moment, the number of input layers of the BP neural network is 4, the number of hidden layers is 3, the number of output layers is 1, and the number of iterations is 100; and then, predicting last 3 days of clearing prices by using first 77 days of clearing prices by taking the first 77 days of time points, D−1, D−2 and D−3 and the original clearing prices as the training data and taking last 3 days of data as test data, wherein the number of input layers is 4, the number of hidden layers is 3, the number of output layers is 1, the number of iterations is 100 (a predicted result is shown in FIG. 1.), and in a predicted result at the time: R²=0.42; forming a column of new predicted data of 80 days of clearing prices as a BP-expansion column; and respectively forming a PSO_BP-expansion column and an LSSVM-expansion column by using a BP neural network optimized by a PSO algorithm and an LSSVM algorithm by adopting the same prediction steps (last 3 days of results predicted by the PSO_BP in the first-round prediction are shown in FIG. 2, and last 3 days of results predicted by the LSSVM are shown in FIG. 3.), wherein the number of evolution of the BP neural network optimized by the PSO algorithm is 200, the population size is 20, the number of iterations is 100, and in a predicted result: R²=0.55; and the number of iterations of the LSSVM algorithm is 100, and in a predicted result: R²=0.40. After the first-round prediction is carried out by adopting the three algorithms, clearing prices and the expansion columns are formed, which are shown in the following table:

TABLE 2
Clearing Prices and Expansion Columns

| Time | | | | LSSVM-expansion | PSO_BP-expansion | BP-expansion | Clearing |
|---|---|---|---|---|---|---|---|
| points | D-1 | D-2 | D-3 | column | column | column | prices |
| 1 | 0 | 0 | 0 | 0 | 17.43 | 3.62 | 0 |
| 2 | 0 | 0 | 0 | 0 | 17.25 | 13.22 | 0 |
| 3 | 10 | 10 | 10 | 10 | 30.29 | 38.48 | 10 |
| . . . | . . . | . . . | . . . | . . . | . . . | . . . | . . . |
| 96 | 0 | 0 | 0 | 0 | −0.65 | 7.15 | 0 |
| 1 | 0 | 0 | 0 | 0 | 17.43 | 3.62 | 0 |
| 2 | 0 | 0 | 0 | 0 | 17.25 | 13.22 | 0 |
| 3 | 30 | 0 | 10 | 32.5 | 36.49 | 46.25 | 90 |
| . . . | . . . | . . . | . . . | . . . | . . . | . . . | . . . |
| 96 | 0 | 0 | 0 | 0 | −0.65 | 7.15 | 0 |
| . . . | . . . | . . . | . . . | . . . | . . . | . . . | . . . |
| 1 | 0 | 0 | 0 | 0 | 20.31 | 9.03 | 0 |
| 2 | 0 | 0 | 0 | 0 | 20.09 | 11.66 | 0 |
| 3 | 180 | 300 | 400 | 245 | 211.62 | 248.45 | 100 |
| . . . | . . . | . . . | . . . | . . . | . . . | . . . | . . . |
| 96 | 0 | 0 | 0 | 0 | −1.35 | −0.96 | 0 |

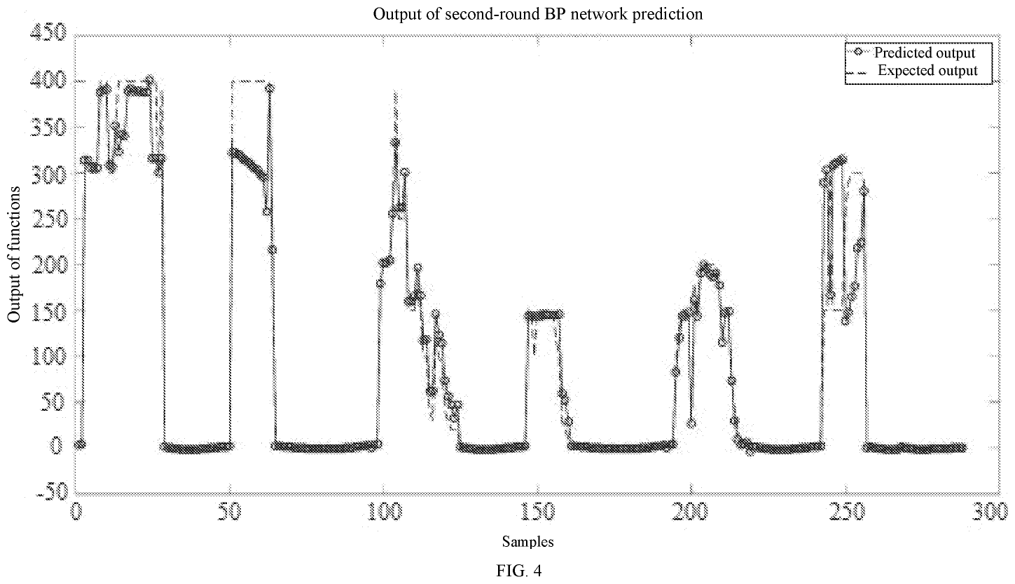

Second-round prediction is carried out by adopting a BP neural network, comprising: predicting last 3 days of clearing prices by using a BP neural network algorithm by taking the first 77 days of time points, D−1, D−2 and D−3, the BP-expansion column, the PSO_BP-expansion column, the LSSVM-expansion column and the original clearing prices as training data and taking the last 3 days of data as the test data, wherein the number of input layers is 7, the number of hidden layers is 7, the number of output layers is 1, and the number of iterations is 100 (a predicted result is shown in FIG. 4.); and in a predicted value at the time and an actual value: R²=0.92. It is observed that the method for predicting the data after the data is expanded by adopting a prediction algorithm is better in actual result, so that the degree of accuracy of the predicted data can be greatly improved,

wherein the degree of accuracy of last k days of predicted values is expressed by R²:

$${R}^{2} = \frac{\sum {( {\hat{y}}_{i} - \overline{y} )}^{2}}{\sum {( {y}_{i} - \overline{y} )}^{2}}$$

wherein ŷᵢ represents a predicted value, yᵢ represents an actual value, and y̅ represents an average value of the last k days of all clearing prices.

The present invention is described in detail by the above embodiments, but the described contents are only preferred embodiments of the present invention and shall not be regarded as the limitation to the implementation scope of the present invention. Any equivalent change, improvement and the like made according to the application scope of the present invention shall belong to the scope of the patent of the present invention.

We claim:

1. A prediction method for a clearing price of an auxiliary service for peak regulation based on deep learning, comprising the following steps:
acquiring continuous N days of historical data of clearing prices of an auxiliary service market for peak regulation and obtaining N×m original clearing prices by taking a clearing interval as a step size, so as to form original clearing data columns; and respectively moving data of the N×m original clearing prices forwards by 1, 2, . . . k days and respectively supplementing missing 1, 2, . . . k days of data by utilizing original clearing prices on a first day, so as to obtain D−1, D−2 . . . D−k data columns;
carrying out first-round training and prediction by adopting a BP (Back Propagation) neural network, a BP neural network optimized by a PSO (Particle Swarm Optimization) algorithm and an LSSVM (Least Square Support Vector Machine), and forming a BP-expansion column, a PSO_BP-expansion column and an LSSVM-expansion column;
carrying out second-round training by utilizing the BP neural network: training the BP neural network by taking first N−k days of time points and D−1, D−2 . . . D−k clearing prices, the BP-expansion column, the PSO_BP-expansion column, the LSSVM-expansion column and the original clearing prices as training data, and taking last k days of data as test data, so as to obtain a trained BP neural network;
carrying out prediction for a clearing price on a to-be-predicted day by utilizing the trained BP neural network.

2. The prediction method for the clearing price of the auxiliary service for peak regulation based on deep learning according to claim 1, wherein the method of carrying out first-round training and prediction by adopting the BP neural network and forming the BP-expansion column comprises:
training the BP neural network by taking the first N−k days of time points and D−1, D−2 . . . D−k clearing prices and the original clearing prices as the training data, and taking output of the BP neural network as first N−k days of clearing data;
training the BP neural network by taking the first N−k days of time points and D−1, D−2 . . . D−k clearing prices and the original clearing prices as the training data and taking the last k days of data as the test data, and carrying out prediction by utilizing the trained BP neural network, so as to obtain last k days of clearing prices;
taking first N−k days of clearing prices and the last k days of clearing prices, which are obtained above, as the BP-expansion column.

3. The prediction method for the clearing price of the auxiliary service for peak regulation based on deep learning according to claim 2, wherein the method of carrying out first-round training and prediction by adopting the BP neural network optimized by the PSO algorithm and the LSSVM and forming the PSO_BP-expansion column and the LSSVM-expansion column is consistent with the method of carrying out first-round training and prediction by adopting the BP neural network and forming the BP-expansion column.

4. The prediction method for the clearing price of the auxiliary service for peak regulation based on deep learning according to claim 1, wherein the method of carrying out prediction for the clearing price on the to-be-predicted day by utilizing the trained BP neural network comprises: acquiring N days of historical data of clearing prices of the auxiliary service market for peak regulation before the to-be-predicted day, so as to form original clearing data columns; respectively moving data of original clearing prices forwards by 1, 2 . . . k days, and supplementing missing 1, 2 . . . k days of data by utilizing original clearing prices on a first day, so as to obtain D−1, D−2 . . . D−k data columns; and inputting the first N−k days of time points and D−1, D−2 . . . D−k clearing prices and the original clearing prices into the trained BP neural network, so as to obtain the clearing price on the to-be-predicted day.

5. A prediction device for a clearing price of an auxiliary service for peak regulation based on deep learning, comprising:
a data acquisition module, used for acquiring the continuous N days of historical data of the clearing prices of the auxiliary service market for peak regulation and obtaining the N×m original clearing prices by taking the clearing interval as the step size, so as to form the original clearing data columns; and respectively moving the data of the N×m original clearing prices forwards by 1,2, . . . k days and respectively supplementing the missing 1,2, . . . k days of data by utilizing the original clearing prices on the first day, so as to obtain the D−1, D−2 . . . D−k data columns;
a data expansion column acquisition module, used for carrying out first-round training and prediction by adopting the BP neural network, the BP neural network optimized by the PSO algorithm and the LSSVM, and forming the BP-expansion column, the PSO_BP-expansion column and the LSSVM-expansion column;
a BP neural network training and acquisition module, used for carrying out second-round training by utilizing the BP neural network: training the BP neural network by taking the first N−k days of time points and D−1, D−2 . . . D−k clearing prices, the BP-expansion column, the PSO_BP-expansion column, the LSSVM-expansion column and the original clearing prices as the training data, and taking the last k days of data as the test data, so as to obtain the trained BP neural network;
a prediction module for the clearing price on the to-be-predicted day, used for carrying out prediction for the clearing price on the to-be-predicted day by utilizing the trained BP neural network.

6. A computing equipment, comprising: one or more processing units; and a storage unit, used for storing one or more programs, wherein when the one or more programs are executed by the one or more processing units, the one or more processing units execute the method of claim 1.

7. A computer readable storage medium with non-volatile program codes capable of being executed by a processor, realizing the steps of the method of claim 1 when computer programs are executed by the processor.
